(19) United States
(12) Patent Application Publication
(10) Pub. No.: US 2012/0075478 A1
(43) Pub. Date: Mar. 29, 2012

(54) Image Sensor, Method Thereof And Devices Having The Same

(75) Inventor: Jung Chak Ahn, Yongin-si (KR)

(73) Assignee: SAMSUNG ELECTRONICS CO., LTD., Suwon-si (KR)

(21) Appl. No.: 13/238,527

(22) Filed: Sep. 21, 2011

(30) Foreign Application Priority Data
Sep. 24, 2010 (KR) 10-2010-0092932

(51) Int. Cl. H04N 5/335; H04N 5/33

(52) U.S. Cl. 348/164; 348/294; 348/E05.09; 348/E05.091

(57) ABSTRACT

An image sensor is provided. The image sensor includes an active pixel configured to pass wavelengths of light and generate an image signal corresponding to the passed wavelengths of light, a first optical black pixel configured to generate a first optical black signal by blocking the light by metal, and a second optical black pixel configured to generate a second optical black signal by blocking the light by a light blocking element.

### CROSS-REFERENCE TO RELATED APPLICATIONS

This application claims priority under 35 U.S.C. §119(a) to Korean Patent Application No. 10-2010-0092932 filed on Sep. 24, 2010, in the Korean Intellectual Property Office (KIPO), the entire contents of which are incorporated herein by reference.

### BACKGROUND

Example embodiments of the inventive concepts relate to an image sensor, and more particularly, to an image sensor for performing an auto dark level compensation efficiently, an operation method thereof and devices having the same.

The image sensor is a device which may convert an optical image into an electric image. The CMOS (complementary metal-oxide semiconductor) image sensor is an image sensor using CMOS technology and may have the disadvantage of experiencing a large dark current. Accordingly, the CMOS image sensor may benefit from a dark level compensation operation to compensate a leakage current occurred by a photo diode, which may be a photoelectric conversion element.

### SUMMARY

Example embodiments of the inventive concepts provide an image sensor compensating dark level, an operation method thereof and devices having the same.

Example embodiments of the inventive concepts are directed to an image sensor, which may include an active pixel configured to pass wavelengths of light and generate an image signal corresponding to wavelengths of the passed light, a first optical black pixel configured to generate a first optical black signal by blocking the light using a metal, and a second optical black pixel configured to generate a second optical black signal by blocking the light using a light blocking element.

The active pixel may be an infrared pixel configured to generate an image signal corresponding to wavelengths in an infrared region among the wavelengths of light. The light blocking element may include a plurality of stacked filters including at least two or more color filters. According to example embodiments of the inventive concepts, the light blocking element may be a black filter.

Example embodiments of the inventive concepts are directed to an image sensor, which may include an auto dark level compensation block configured to perform dark level compensation by using an image signal and one of a first optical black signal and a second optical black signal, and a pixel array. The pixel array may include an active pixel configured to pass wavelengths of light and generate the image signal corresponding to passed wavelengths of light, a first optical black pixel configured to generate the first optical black signal by blocking the light using a metal, and a second optical black pixel configured to generate the second optical black signal by blocking the light using a light blocking element.

The auto dark level compensation block may be configured to compare a level of the image signal with a reference level and selects one of the first optical black signal and the second optical black signal according to a comparison result.

The auto dark level compensation block may be configured to perforin a dark level compensation by using the first optical black signal when a level of the image signal is greater than the reference level.

Example embodiments of the inventive concepts are directed to an image sensor system, which may include the image sensor and an image processor configured to control the image sensor.

Example embodiments of the inventive concepts are directed to an operation method of an image sensor, which may include passing wavelengths of incident light and generating an image signal corresponding to wavelengths of the passed light by using an active pixel, blocking the light by metal and generating a first optical black signal by using a first optical black pixel, blocking the light by a first color filter and generating a second optical black signal by using a second optical black pixel, selecting, by an auto dark level compensation block, one of the first optical black signal and the second optical black signal, and performing, by the auto dark level compensation block, a dark level compensation by using one of the first optical black signal and the second optical black signal and the image signal.

Example embodiments of the inventive concepts are directed to an image sensor which may include one or more active pixels configured to detect light and generate an image signal based on the detected light, first and second optical black pixels configured to block light and generate first and second optical black signals, respectively, the first and second optical black pixels being structured differently, and an auto dark level compensation unit configured to choose one of the first and second optical black signals as a selected optical black signal based on the image signal, and perform a dark level compensation operation on the image signal using the selected optical black signal.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates a schematic block diagram of an image sensing system including an image sensor according to example embodiments of the inventive concepts;

FIG. 2 illustrates a plane diagram of a pixel array illustrated in FIG. 1 according to example embodiments of the inventive concepts;

FIG. 3 illustrates a cross-sectional diagram of an active pixel illustrated in FIG. 2 according to example embodiments of the inventive concepts;

FIG. 4 illustrates a circuit diagram of an unit pixel circuit including a photoelectric conversion element illustrated in FIG. 3 according to example embodiments of the inventive concepts;

FIG. 5 illustrates a cross-sectional diagram an optical black pixel illustrated in FIG. 2 according to example embodiments of the inventive concepts;

FIG. 6 illustrates another cross-sectional diagram of the optical black pixel illustrated in FIG. 2 according to example embodiments of the inventive concepts;

FIG. 7 is a detailed block diagram illustrating the image sensor illustrated in FIG. 1 according to example embodiments of the inventive concepts;

FIG. 8 is a flowchart illustrating an operation method of an image sensor according to example embodiments of the inventive concepts; and

FIG. 9 illustrates a schematic block diagram of another image sensing system including an image sensor according to example embodiments of the inventive concepts.

### DETAILED DESCRIPTION OF THE PREFERRED EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

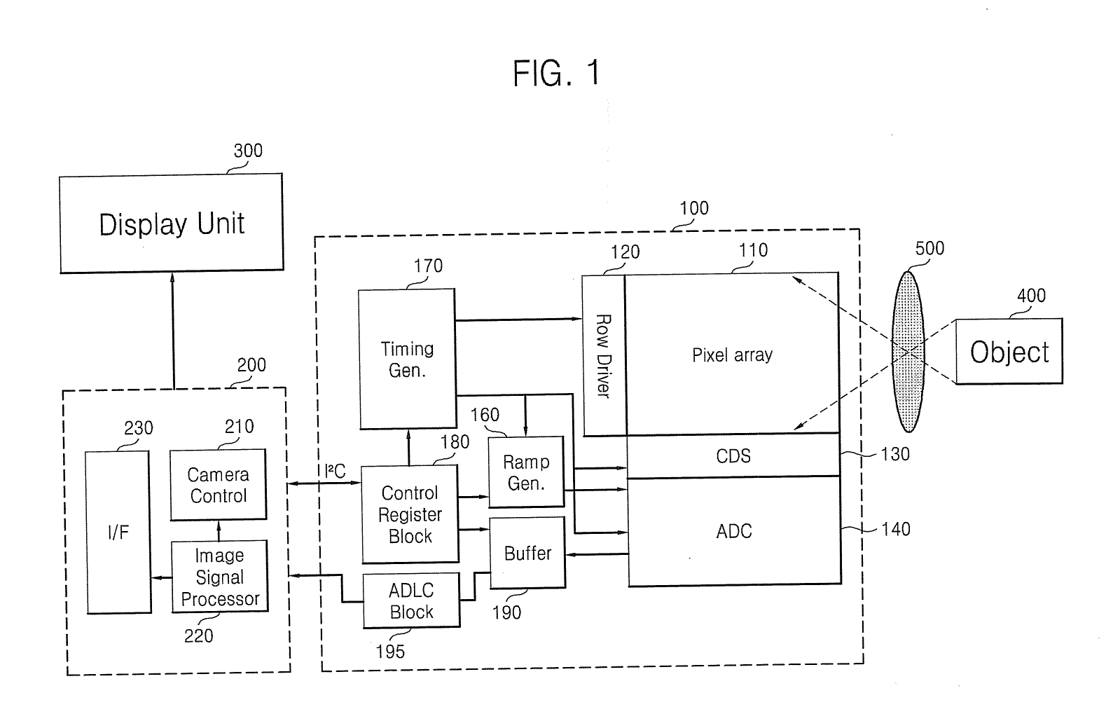

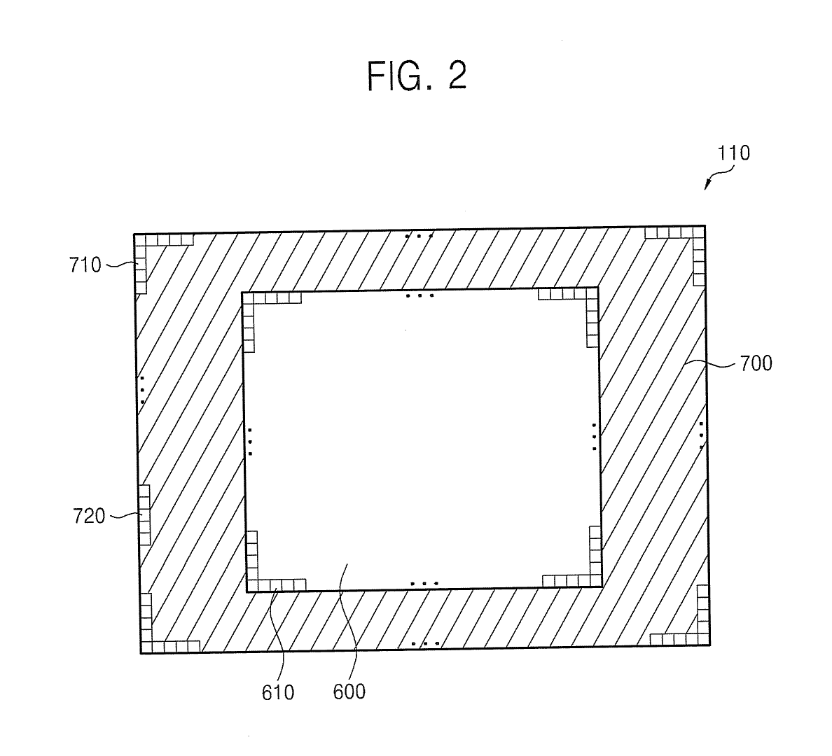

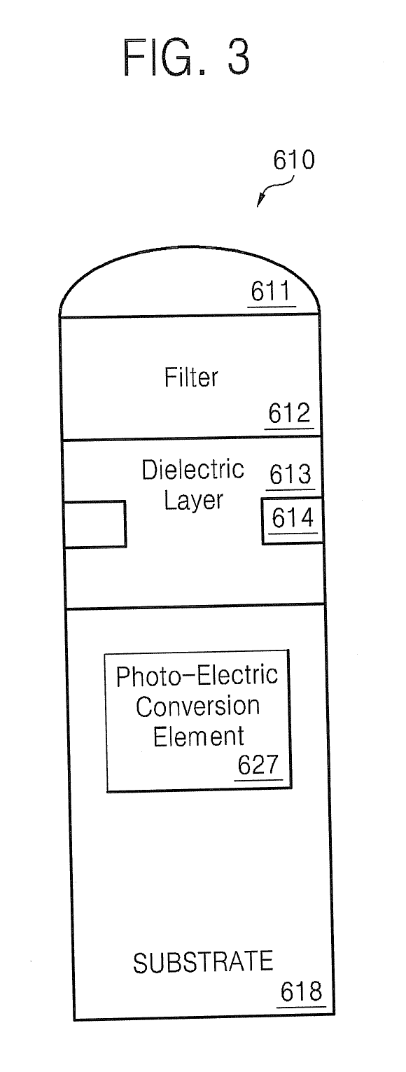

FIG. 1 illustrates a schematic block diagram of an image sensing system including a pixel array according to example embodiments of the inventive concepts, FIG. 2 illustrates a plane diagram of the pixel array illustrated in FIG. 1, and FIG. 3 illustrates a cross-sectional diagram of pixels illustrated in FIG. 2 according to example embodiments of the inventive concepts.

Referring to FIG. 1, the image sensor 100 includes a pixel array 110, a row driver 120, a correlated double sampling (CDS) block 130, an analog-to-digital converter (ADC) 140, a ramp signal generator 160, a timing generator 170, a control register block 180, a buffer 190 and an auto dark level compensation (ADLC) block 195.

The image sensor 100 may sense an image of an object 400 captured or picked-up through a lens 500 according to a control of a digital signal processor (DSP) 200, and the DSP 200 may output an image which is sensed and output by the image sensor 100 to a display unit 300. The display unit 300 may be any device outputting and displaying an image. For example, the display unit 300 may be an output terminal of personal computer (PC), laptop computer, a mobile communication device, or portable device.

The DSP 200 includes a camera control 210, an image signal processor ISP 220 and an interface (I/F) 230. The camera control 210 embodied hardware or software may control an operation of the control register block 180. The camera control 210 may control an operation of the image sensor 100 via the control register block 180, by using an inter-integrated circuit I2C, however, example embodiments of the inventive concepts are not restricted thereto.

The ISP 220 may receive an image data output from the ADLC block 195, process or treat the received image data, and output the processed or treated image data to the display unit 300 through the I/F 230. Though, the ISP 220 is illustrated as being located inside the DSP 200 in FIG. 1, according to example embodiments of the inventive concepts, the ISP 220 may be included inside the image sensor 100. Further, according to example embodiments of the inventive concepts the image sensor 100 and the ISP 220 may be included in, for example, a package, e.g., a multi-chip package (MCP).

The pixel array 110 may be, for example, a plurality of photo sensitive elements, for example photo diodes or pinned photo diodes.

Referring to FIG. 2, the pixel array 110 includes an active pixel region 600 and an optical black pixel region 700. The active pixel region 600 includes a plurality of active pixels 610. Each of the plurality of active pixels 610 may be a pixel generating an image signal corresponding to wavelengths of passed light after passing wavelengths of light.

Referring to FIGS. 2 and 3, each of the plurality of active pixels 610 includes a microlens 611, a filter 612, a dielectric layer 613, a metal 614, a photo-electric conversion element 627 and a substrate 618.

The microlens 611 may perform a function of concentrating light incident on a surface of the microlens 611 which originates from a position external to the microlens 611. The filter 612 may be, for example, a color filter passing wavelengths of a visible region among wavelengths of light input through the microlens 611, or an infrared filter passing wavelengths of an infrared region among wavelengths of the light.

For example, the color filter may be at least one of a red filter passing wavelengths of a red region among wavelengths of the visible region, a green filter passing wavelengths of a green region among wavelengths of the visible regions, or a blue filter passing wavelengths of a blue region among wavelengths of the visible region. According to example embodiments of the inventive concepts, the color filter may also be, for example, at least one of a cyan filter, a yellow filter and a magenta filter.

The dielectric layer 613 may be formed between the filter 612 and the photoelectric conversion element 627. The dielectric layer 613 may be formed in, for example, an oxide layer or a composite layer including an oxide layer and a nitride layer.

A part of metal 614 may be removed through a heat treatment process to pass light. Accordingly, the active pixel 610 may generate an image signal corresponding to wavelengths of light passed after passing wavelengths of light.

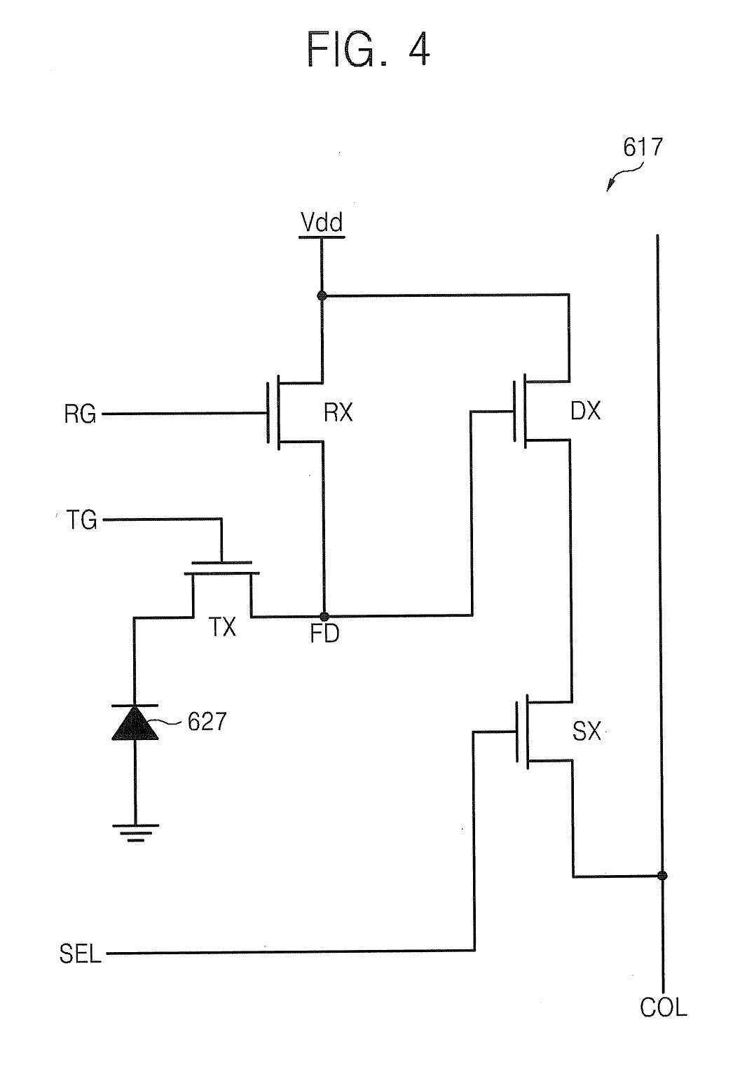

FIG. 4 illustrates a circuit diagram of a unit pixel circuit including a photoelectric conversion element illustrated in FIG. 3 according to example embodiments of the inventive concepts. Referring to FIG. 4, the unit pixel circuit 617 includes a photoelectric conversion element 627 and four transistors RX, TX, DX and SX.

The photoelectric conversion element 627 may generate photo-charges in response to light incident on a surface of the photoelectric conversion element 627 which originates from a position external to the photoelectric conversion element 627. The photoelectric conversion element 627 may be, for example, a photo diode, a photo transistor, a photo gate or a pinned photo diode (PPD) as a photo sensing element.

The reset transistor RX may reset a floating diffusion region FD in response to a reset signal RG. The transmission transistor TX may transmit photo-charges generated by the photoelectric conversion element 627 to the floating diffusion region FD in response to a transmission signal TG. The drive transistor DX may perform a role of a source follower buffer amplifier. According to example embodiments of the inventive concepts, the drive transistor DX may perform a buffering operation in response to photo-charges charged in the floating diffusion region FD. The selection transistor SX may output a pixel signal output from the drive transistor DX to a column line COL in response to a selection signal SEL.

Though, FIG. 4 illustrates the unit pixel circuit 617 including a photoelectric conversion element 627 and four transistors TX, RX, DX and SX, example embodiments of the inventive concepts are not limited to this description and the unit pixel circuit 617 may have other structures. Referring to FIG. 3, the substrate 618 may include, for example, at least one of a P-type silicon substrate or a N-type silicon substrate. Referring to FIG. 2, the optical black pixel region 700 includes a plurality of optical black pixels 710 and 720. Each of the plurality of optical black pixels 710 and 720 may generate an optical black signal by blocking incident light.

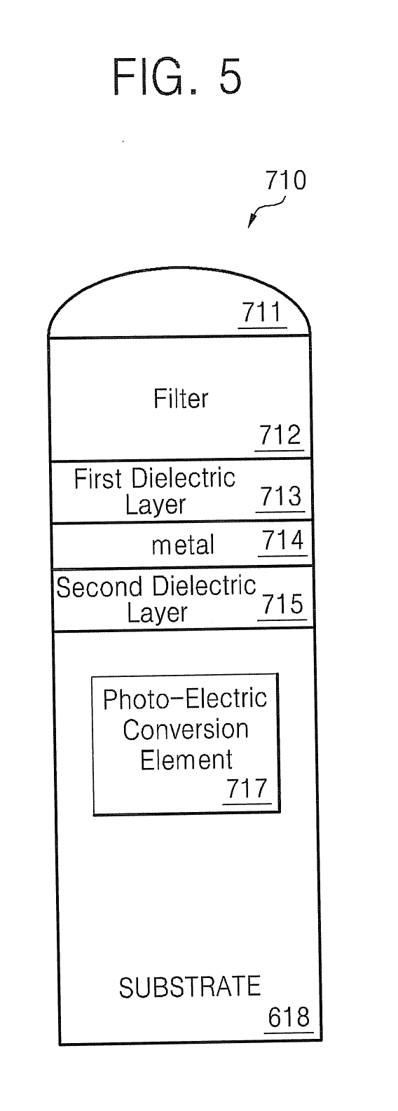

FIG. 5 illustrates a cross-sectional diagram of the optical black pixel illustrated in FIG. 2 according to example embodiments of the inventive concepts. Referring to FIGS. 2 and 5, a first optical black pixel 710 among the plurality of active pixels 710 and 720 includes a microlens 711, a filter 712, a first dielectric layer 713, a metal 714, a second dielectric layer 715, a photoelectric conversion element 717 and a substrate 618.

The microlens 711 concentrates light incident on a surface of the microlens 711 which originates from a position external to the microlens 711. The filter 712 may include, for example, a color filter passing wavelengths of a visible region among wavelengths of light output from the microlens 711, or an infrared filter passing wavelengths of an infrared region among wavelengths of the light. According to example embodiments of the inventive concepts, the first optical black pixel 710 may not include the filter 712.

The first dielectric layer 713 may be formed under the filter 712 and a second dielectric layer 715 may be formed on the photoelectric conversion element 717. The first dielectric layer 713 and the second dielectric layer 715 may be formed of, for example, an oxide layer or a composite layer including an oxide layer and a nitride layer.

The metal 714 may be formed between the first dielectric layer 713 and the second dielectric layer 715. The metal 714 may include, for example in Au, Ag, Cu or Al. Accordingly, the metal 714 formed in the first optical black pixel 710 may intercept or block light, so that the first optical black pixel 710 may generate a first optical black signal having a dark level. The photoelectric conversion element 717 may have, for example, the same structure and operation as the photoelectric conversion element 627 discussed above with reference to FIGS. 2 and 3, and thus a detailed explanation thereof is omitted. According to example embodiments of the inventive concepts, the first optical black pixel 710 may not include the photoelectric conversion element 717.

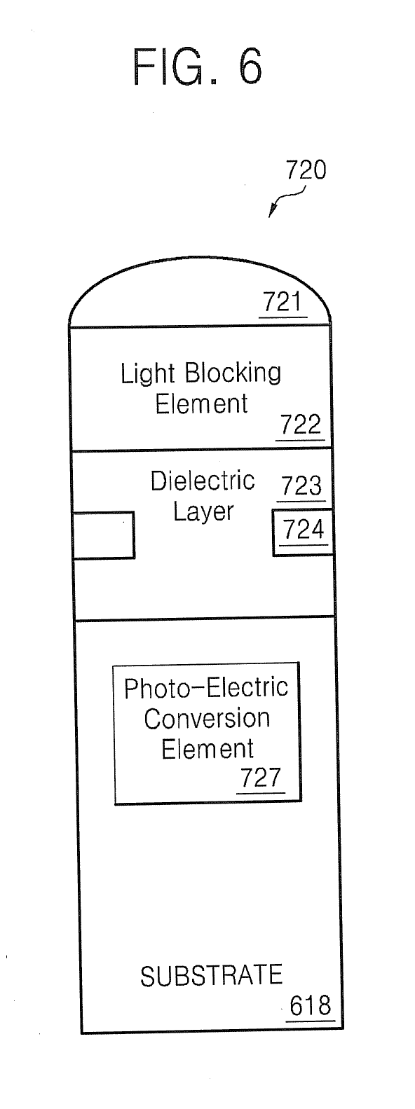

FIG. 6 illustrates another cross-sectional diagram of the optical black pixel illustrated in FIG. 2 according to example embodiments of the inventive concepts. Referring to FIGS. 2 and 6, a second optical black pixel 720 among the plurality of active pixels 710 and 720 includes a microlens 721, a light blocking element 722, a dielectric layer 723, a metal 724, a photoelectric conversion element 727 and a substrate 618.

The microlens 721 may concentrate light incident on a surface of the microlens 721 which originates from a position external to the microlens 721. The dielectric layer 723 may be formed between the light blocking element 722 and the photoelectric conversion element 727. The dark level of an active pixel 610 may be different from a dark level of the first optical black pixel 710 due to, for example, the dark level of the active pixel 610 being subject to a heat treatment process. A difference between a dark level of the active pixel 610 and a dark level of the first optical black pixel 710 may prevent or impair performance of a complete dark level compensation operation. Accordingly, to compensate the difference induced by the heat treatment process of the active pixel 610, a part of a metal 724 of the second optical black pixel 720 may be removed by the heat treatment process in the same manner discussed above with reference to the active pixel 610.

The second optical black pixel 720 may block light to generate a second optical black signal. Accordingly, the second optical black pixel 720 includes the light blocking element 722 which may block light. According to example embodiments of the inventive concepts, the light blocking element 722 may include, for example a black filter.

According to example embodiments of the inventive concepts, the light blocking element 722 may include, for example at least two stacked color filters. For example, the light blocking element 722 may be constructed by stacking a red filter and a blue filter, a red filter and a green filter or a green filter and a blue filter. The photoelectric conversion element 727 may have, for example, the same structure and operation as the photoelectric conversion element 627 discussed above with reference to FIGS. 2 and 3, and thus a detailed explanation thereof is omitted.

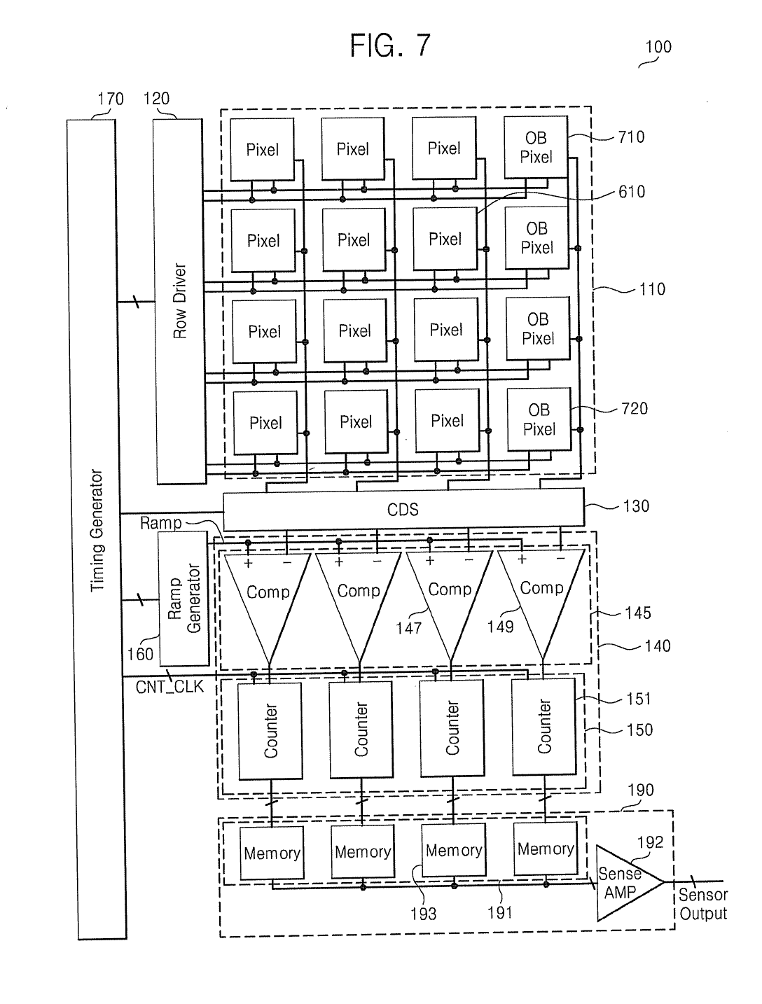

FIG. 7 is a detailed block diagram illustrating the image sensor illustrated in FIG. 1. Referring to FIGS. 1, 2 and 7, a timing generator 170 may control each operation of the row driver 120, the ADC 140 and the ramp signal generator 160 by outputting at least one control signal to each of a row driver 120, an ADC 140 and a ramp signal generator 160.

The control register block 180 may control some or all operations of the ramp signal generator 160, the timing generator 170 and the buffer 190 by outputting at least one control signal to some or all of the ramp signal generator 160, the timing generator 170 and a buffer 190. According to example embodiments of the inventive concepts, the control register block 180 may operate under control of a camera control 210. The camera control 210 may be, for example, a control unit implemented by hardware or software.

The row driver 120 may drive the pixel array 110 by row. For example, the row driver 120 may generate a row selection signal. The pixel array 110 includes a plurality of active pixels, for example the active pixels 610, and a plurality of optical black pixels, for example the first optical black pixel 710 and the second optical black pixel 720.

Each of the plurality of active pixels, for example the active pixels 610, may sense an incident light and output an image reset signal and an image signal to a CDS 130. Each of the plurality of optical black pixels, e.g., the first optical black pixel 710 and the second optical black pixel 720, may output an optical black reset signal and an optical black signal to the CDS 130.

The CDS 130 may perform a correlated double sampling (CDS) on each of the image reset signal and the image signal which are input. Moreover, the CDS 130 may perform a correlated double sampling (CDS) on each of the optical black reset signal and the optical black signal which are input. The ADC 140 may output a comparison signal by comparing a ramp signal Vramp supplied from the ramp signal generator 160 with a correlated double sampled signal output from the CDS 130, and output a count value to the buffer 190 by counting the comparison signal according to a clock CNT_CLK.

Referring to FIG. 7, the ADC 140 includes a comparison block 145 and a count block 150. The comparison block 145 includes a plurality of comparators Comp. Each of the plurality of comparators Comp is connected to the correlated double sampling block 130 and the ramp signal generator 160. According to example embodiments of the inventive concepts, the correlated double sampling block 130 may be connected to each first input terminal of the plurality of comparators Comp, and the ramp signal generator 160 may be connected to each second input terminal of the plurality of comparators Comp.

Each of the plurality of comparators Comp may output a comparison signal to an output terminal by receiving and comparing an output signal of the correlated double sampling block 130 with a ramp signal generated by the ramp signal generator 160.

For example, a comparison signal output from a first comparator 147 may correspond to a difference between an image signal and an image reset signal, which are changed according to illuminance of light incident from an external position, and the difference between the image signal and the image reset signal may be output according to slope of a ramp signal by using the ramp signal. A comparison signal output from a second comparator 149 may correspond to difference between an optical black signal and an optical black reset signal, and the difference between the optical black signal and the optical black reset signal may be output according to slope of a ramp signal by using the ramp signal.

The ramp signal generator 160 may operate based on a control signal output from the timing generator 170.

The count block 150 includes a plurality of counters 151. Each of the plurality of counters 151 is connected to each output terminal of a plurality of comparators Comp, counts and outputs the comparison result signal in a digital signal according to a clock CNT_CLK input from the timing generator 170. According to example embodiments of the inventive concepts, the count block 150 may output a plurality of digital image signals and a plurality of digital optical black signals.

According to example embodiments of the inventive concepts, the clock CNT_CLK may be generated by a count controller (not shown) located inside the count block 150 or inside the timing generator 170 based on a count control signal generated by the timing generator 170.

According to example embodiments of the inventive concepts, the counter 151 may include, for example an up/down counter or a bit-wise inversion counter. According to example embodiments of the inventive concepts, the bit-wise inversion counter may perform a similar operation to the up/down counter. For example, since the bit-wise inversion counter may perform a function of performing only up count and a function of inverting all bits inside the counter into 1's complement when a specific signal is input, it may be possible to invert a count value into 1's complement, i.e., a negative value, by using it.

The buffer 190 may sense, amplify and output a plurality of digital image signals and a plurality of digital optical black signals output from the ADC 130 after temporally storing them. According to example embodiments of the inventive concepts, the buffer 190 includes a memory block 191 and a sense amp 192. The memory block 191 includes a plurality of memories 193 for storing a count value output from each of the plurality of counters 151. For example, the count value may be one of a digital image signal generated by the active pixel 610, a first digital optical black signal generated by the first optical black pixel 710 and a second digital optical black signal generated by the second optical black pixel 720.

The sense amp 192 may sense a count value output from the memory block 191.

The buffer 190 may include a column memory block 191 each included in each row for storing data temporarily and the sense amp SA for sensing and amplifying a digital signal output from the ADC 130.

The auto dark level compensation block 195 may perform a dark level compensation by using, for example, one or more of a first digital optical black signal, a second digital optical black signal, and a digital image signal. The first digital optical black signal may indicate a signal generated by the first optical black pixel 710, the second digital optical black signal may indicate a signal generated by the second optical black pixel 720, and the digital image signal may indicate a signal generated by the active pixel 610.

The auto dark level compensation block 195 may compare a level of the digital image signal with a reference level and select one of the first digital optical black signal and the second digital optical black signal according to a comparison result.

For example, when the level of the digital image signal is greater than the reference level, the auto dark level compensation block 195 may perform a dark level compensation by using the first digital optical black signal.

Accordingly, the image sensor 100 may output image data whose dark level is compensated to an image processor 200 by using the auto dark level compensation block 195.

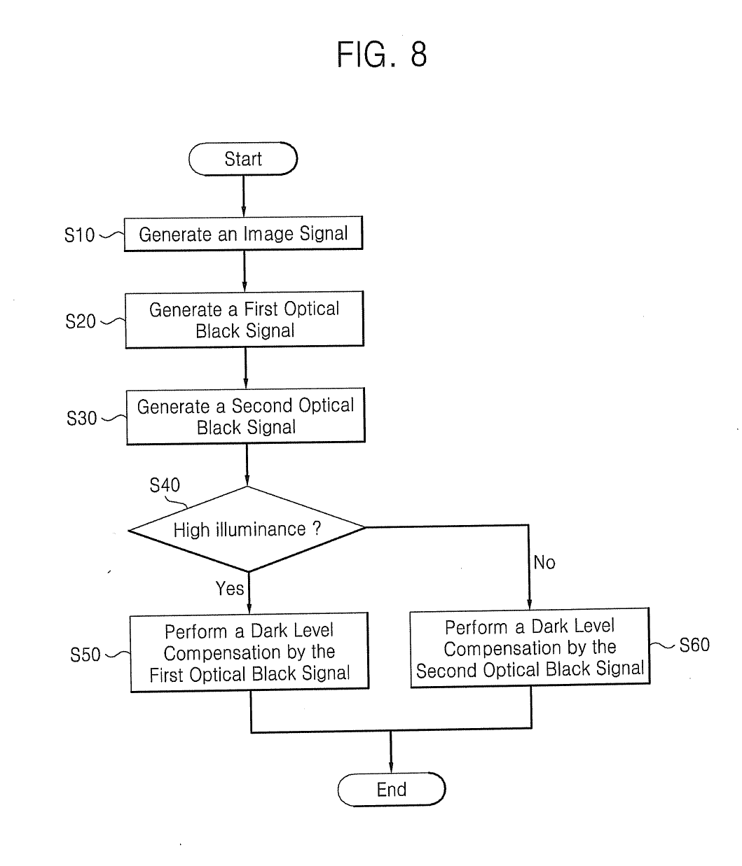

FIG. 8 is a flowchart illustrating an operation method of an image sensor according to example embodiments of the inventive concepts. Referring to FIGS. 1 to 8, in step S10, the active pixel 610 generates an image signal corresponding to wavelengths of passed light after passing wavelengths of light.

In step S20, the first optical black pixel 710 generates a first optical black signal by blocking the light by the metal 714. In step S30, the second optical black pixel 720 generates a second optical black signal by blocking the light by the light blocking element 722.

In step S40, The auto dark level compensation block 195 determines if the light is in high illuminance. In step S50, the auto dark level compensation block 195 performs a dark level compensation by using the first optical black signal when determining that the light is in high illuminance, for example when the auto dark level compensation block 195 determines that a level of the image signal is greater than the reference level.

In step S60, the auto dark level compensation block 195 performs a dark level compensation by using the second optical black signal when determining that the light is not in high illuminance, for example when the auto dark level compensation block 195 determines that a level of the image signal is less than the reference level.

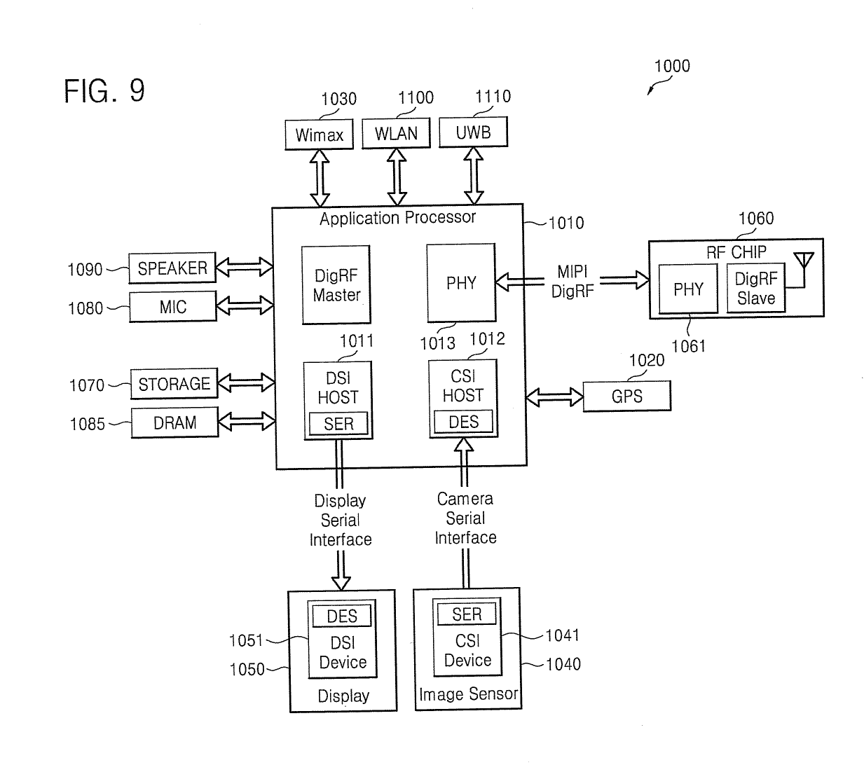

FIG. 9 illustrates a schematic block diagram of another image sensing system including an image sensor according to example embodiments of the inventive concepts. Referring to FIG. 9, an image sensing system 1000 may be included in, for example, a data processing device which may use or support a Mobile Industry Processor Interface (MIPI®) interface, e.g., a cellular phone, a personal digital assistant (PDA), a portable multimedia player (PMP), a smart phone, or a tablet PC.

The image sensing system 1000 includes an application processor 1010, an image sensor 1040 and a display 1050.

The camera serial interface (CSI) host 1012 included in the application processor 1010 may communicate serially with a CSI device 1041 of the image sensor 1040 through a CSI. According to example embodiments of the inventive concepts, for example, an optical deserializer (not shown) may be included in, for example the CSI host 1012, and an optical serializer (not shown) may be included in, for example the CSI device 1041. The image sensor 1040 may be displayed the image sensor 100 explained in FIGS. 1 to 8.

The display serial interface (DSI) host 1011 included in the application processor 1010 may communicate serially with a DSI device 1051 of a display 1050 through a DSI. According to example embodiments of the inventive concepts, an optical serializer (not shown) may be included in, for example, the DSI host 1011 and an optical deserializer (not shown) may be included in, for example, the DSI device 1051. A physical layer (PHY) 1013 of the image sensing system 1000 and a PHY 1061 of a RF chip 1060 may transmit and receive data according to MIPI DigRF.

The image sensing system 1000 may further include a GPS 1020, a storage 1070, a microphone 1080, a dynamic random access memory (DRAM) 1085 and a speaker 1090, and may communicate by using Worldwide Interoperability for Microwave Access (Wimax) module 1030, wireless local area network (WLAN) module 1100 and ultra wide band (UWB) module 1110.

The image sensor according to example embodiments of the inventive concepts may compensate a dark level efficiently by using one of different types of optical black pixels according to light illuminance.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. An image sensor comprising:
an active pixel configured to pass wavelengths of incident light, and generate an image signal corresponding to the passed wavelengths of light after;
a first optical black pixel configured to generate a first optical black signal by blocking the incident light using a metal; and
a second optical black pixel configured to generate a second optical black signal by blocking the incident light using a light blocking element.

2. The image sensor of claim 1, wherein the active pixel is an infrared pixel configured to generate an image signal corresponding to wavelengths of an infrared region among wavelengths of the light.

3. The image sensor of claim 1, wherein the light blocking element includes a plurality of stacked filters, the plurality of stacked filters including at least two or more color pixels.

4. The image sensor of claim 1, wherein the light blocking element is a black filter.

5. The image sensor of claim 1, further comprising:
an auto dark level compensation block configured to perform a dark level compensation operation by using the image signal and one of the first optical black signal and the second optical black signal.

6. The image sensor of claim 5, wherein the auto dark level compensation block is configured to compare a level of the image signal with a reference level and select one of the first optical black signal and the second optical black signal according to a comparison result.

7. The image sensor of claim 6, wherein the auto dark level compensation block is configured to perform a dark level compensation operation by using the first optical black signal when a level of the image signal is greater than the reference level.

8. The image sensor of claim 5, wherein the active pixel is an infrared pixel configured to generate an image signal corresponding to wavelengths in an infrared region among wavelengths of the light.

9. The image sensor of claim 5, wherein the light blocking element includes a plurality of stacked filters, the plurality of stacked filters including at least two or more color filters.

10. The image sensor of claim 5, wherein the light blocking element is a black filter.

11. An image sensing system comprising:
the image sensor of claim 5; and
an image processor configured to control the image sensor.

12. The image sensing system of claim 11, wherein the auto dark level compensation block is configured to compare a level of the image signal with a reference level and select one of the first optical black signal and the second optical black signal according to a comparison result.

13. The image sensing system of claim 12, wherein the auto dark level compensation block is configured to perform a dark level compensation operation by using the first optical black signal when a level of the image signal is greater than the reference level.

14. The image sensing system of claim 11, wherein the light blocking element is embodied by stacking two or more color filters.

15. (canceled)

16. An image sensor comprising:
one or more active pixels configured to detect light and generate an image signal based on the detected light;
first and second optical black pixels configured to block light and generate first and second optical black signals, respectively, the first and second optical black pixels being structured differently; and
an auto dark level compensation unit configured to choose one of the first and second optical black signals as a selected optical black signal based on the image signal, and perform a dark level compensation operation on the image signal using the selected optical black signal.

17. The image sensor of claim 16 wherein the auto dark level compensation unit is configured to choose between the first and second optical black signal based on an illuminance of the image signal.

18. The image sensor of claim 16 wherein the first optical black pixel includes a filter configured to pass light, and a metal layer configured to block light incident upon the first optical black pixel.

19. The image sensor of claim 18 wherein the second optical black pixel includes a light blocking element configured to block light.

20. The image sensor of claim 19 wherein the auto dark level compensation unit is configured such that if an illuminance of the image signal is above a reference level, the auto dark level compensation unit selects the first optical black signal as the selected signal, and if an illuminance of the image signal is not above a reference level, the auto dark level compensation unit selects the second optical black signal as the selected signal.

21. An image sensing system comprising:
the image sensor of claim 20; and
an image processor configured to control the image sensor.
